(19) United States
(12) Patent Application Publication
(10) Pub. No.: US 2011/0248060 A1
(43) Pub. Date: Oct. 13, 2011

(54) Rotatable mobile device holder for a motor vehicle sun visor

(76) Inventors: John F. Luk, Flushing, NY (US); Georgiana Hsu-Luk, Flushing, NY (US)

(21) Appl. No.: 13/134,643

(22) Filed: Jun. 13, 2011

Related U.S. Application Data
(63) Continuation-in-part of application No. 13/065,122, filed on Mar. 15, 2011.
(60) Provisional application No. 61/340,278, filed on Mar. 15, 2010.

(51) Int. Cl. B60R 11/00

(52) U.S. Cl. 224/567

(57) ABSTRACT

A protective holder for a mobile device includes attaching portions for mounting to a motor vehicle sun visor. The attaching portions include clips, elastic straps, Velcro fasteners, double-sided sticking tape strips or hooks. The holder includes a main opening for the mobile device with adjoining sides. The adjoining sides include additional openings to provide access to the power switch, power charging jack, speaker, memory card, camera, flash, microphone, keypad, volume adjust, headphone jack, HDMI video jack, LCD or image touch screen. A rotating mechanism may be used for swiveling the mobile device from portrait or landscape positions and vice-versa while it is inserted in the holder. The mobile device can be a cell phone or a smartphone that can serve as a portable GPS navigation device.

### RELATED U.S. APPLICATION DATA

This patent application claims benefit of U.S. Non-Provisional Application No. 13/065,122 filed on Mar. 15, 2011, which claims benefit of U.S. Provisional Application No. 61/340,278 filed on Mar. 15, 2010.

### FIELD OF THE INVENTION

The present invention relates generally to holders for mobile devices and in particular to holders for cell phones and portable smartphones for mounting to the sun visor of a motor vehicle.

### BACKGROUND OF THE INVENTION

Mobile devices including cell phones and portable smartphone are widely available today as they become cheaper to own with different carriers fighting to grab their market share in the portable mobile device industry. The service providers of cell phones and portable smartphones are now working hand in hand with makers of portable GPS navigation companies to install their software and applications into all mobile devices including cell phones and portable smartphones. Such applications include navigation software that uses the built-in GPS located in the mobile phones. In essence, the cell phone or portable smartphone is now the mobile GPS navigation device. The navigation software applications are available from companies like Tom Tom, Garmin, Mio, Navigon and Magellan just to name a few. The larger carriers like Verizon Wireless even have their own built-in GPS Navigation application called VZ Navigator. The other cell phone service providers will surely follow suit if they haven't already done so.

A GPS navigation device is any device that receives Global Positioning System (GPS) signals for the purpose of determining the present location. These devices are used in military, aviation, marine and consumer product applications. Dedicated devices have various degrees of mobility.

Portable hand-held, outdoor or sport receivers have replaceable batteries that can run them for several hours, making them suitable for hiking, bicycle riding and other activities located far from an electric power source. Their screens are small, and some do not show color in part to save power. Cases are rugged and some are even water resistant.

Other receivers often called mobile GPS navigation devices are intended primarily for use in a motor vehicle, but have a small rechargeable internal battery that can power them for an hour or two when disconnected from an electric power source. Mobile GPS navigation devices for use in a motor vehicle may be permanently installed and are available as a factory option at a premium price. Because of the high price for the factory option and the dropping cost for mobile GPS navigation devices, the mobile GPS navigation devices are becoming more and more popular for use by consumers both for its convenience and affordable price.

The point of purchase mobile GPS navigation device usually comes standard with a swivel ball and suction cup mount that can be affixed to the inside windshield surface or on top of the dashboard. Since the mobile GPS navigation device is meant primarily to be used while in the motor vehicle, most consumers leave them in the glove department or under the seat. There are some disadvantages to the standard swivel ball and suction cup mounting hardware provided by most mobile GPS navigation device manufacturers. There is a possibility that the suction cup or the surface it is meant to adhere to may get dirty and may cause the GPS navigation device mounting to be unreliable. In addition, the visible presence of a swivel ball and suction cup mount left inside a parked vehicle or the markings left behind by the suction cup feet on the windshield or hardware left on top of the dashboard will all raise the suspicion that a GPS navigation device may be left behind by the owner and hidden somewhere inside the motor vehicle. This presents a possible target for a thief to break into the motor vehicle and to cause damage and unwanted repair expense.

There are safety and legal issues as well. State law prohibits drivers in California and Minnesota from using the swivel ball and suction cup mounts on their windshields while operating motor vehicles. California state law permits the GPS systems to be mounted in a 7-inch square in the lower corner of the windshield farthest removed from the driver or in a 5-inch square in the lower corner of the windshield nearest to the driver, provided the system is used only for door-to-door navigation while the motor vehicle is being operated and is outside of an airbag deployment zone. Other state or local laws may also prohibit drivers from using swivel ball and suction cup mounts on their windshields or operating the GPS system while the car is in motion. Dashboard or friction mounting options should be used. For more details, see California Vehicle Code Section 26708(a) and Minnesota Statutes 2009, Section 169.71.

With the ever growing number of mobile GPS navigation devices being used, there becomes a need for an improved means for mounting and attaching the mobile GPS navigation devices besides using the standard swivel ball and suction cup mount provided with the mobile GPS navigation devices and that will also help reduce the possibility of theft and provide a safer mounting alternative to the consumer.

California Vehicle Code Section 26708(b) for Material Obstructing or Reducing Driver's View does not apply to adjustable nontransparent sun visors that are mounted forward of the side windows and are not attached to the glass. Minnesota Statutes 2009, Section 169.71 for Windshields prohibits a person from driving or operating any motor vehicle with any objects suspended between the driver and the windshield, other than sun visors.

The present invention is designed to overcome the drawbacks of the standard swivel ball and suction cup mount by providing a holder for the GPS device that includes a clip or other mounting hardware including elastic straps, Velcro fasteners, double-sided sticking tape strips or hooks that will allow the holder to be attached to the sun visor provided in any motor vehicle. The holder does not rely on a suction cup, but simply mounts to the sun visor and becomes an integral part of the sun visor. The holder is designed to be mounted to the sun visor with the front LCD touch screen of the GPS navigation device facing the user. The holder will also have provisions for access to the power switch, power charging jack, speaker, memory card, and LCD touch screen. Normal use of the vehicle sun visor can continue while driving, and can momentarily be switched to the side of the vehicle when the power charging cable is detached or the mobile GPS navigation device is running on internal battery power. A clear view of the sky is also not necessary for the mobile GPS navigation devices to function properly, and the motor vehicle sun visors do not interfere with the GPS satellite signal reception.

According to an Aug. 13, 2002 article in USA TODAY by Earle Eldridge, entitled “TVs in steering wheels raise safety concerns”, twenty-nine states prohibit video screens in motor vehicles where the driver can see them; eight states prohibit video screen in motor vehicles where the driver can see them with exemptions for navigations systems; and thirteen states have no laws or information is not available regarding video screens located in the front or are visible to the driver of the motor vehicle.

For the majority of the time, the reliance on the GPS voice prompt guidance system is really all that is necessary when using the mobile GPS navigation device in the holder with viewing of the LCD touch screen done only momentarily and keeping your eyes on the road most of the time. Being that the mobile GPS navigation device is within eye's view, the driver does not have to take his eye off the road by looking at the top or bottom of the windshield, or down at the dashboard when the GPS device is mounted on the standard swivel ball and suction cup hardware. When the GPS device is not in use, it is simply turned off and is concealed from direct view from outside of the motor vehicle. The holder has a low profile and can sit flush to the flat surface of the sun visor allowing it to be easily concealed from the prying eyes of thieves.

The holder for a vehicle sun visor can be made from simple materials including plastic, silicone rubber, cloth fabric or leather for the body, and plastic or metal for the mounting clip. The holder can be made quickly and inexpensively. It is designed to fit the majority of square and widescreen mobile GPS navigation devices made by different manufacturers. It can be mounted to the driver or passenger side sun visors. It can be mounted to the sun visor when the sun visor is in the up position or it can be mounted to the sun visor when the sun visor is in the down position.

The present invention will provide convenience, piece of mind, and an additional and more reliable mounting option for the consumer. Because of its convenience and ease of use, the holder can be used to contain other mobile devices including cellular telephones or cell phones, radar detectors, PDAs and the like or can be used as a convenient documents or cigarette box holder. The location of the holder attached to the sun visor provides easy access and concealed use for mobile devices or other objects that will fit into the holder.

### DESCRIPTION OF THE RELATED ART

There are patents in the public domain that include holders for cell phones. electronic devices and the like, but there is no reference to a specific multi-purpose holder that can accept a mobile device like a cell phone or a portable smartphone that can be mounted onto a motor vehicle sun visor and allowing the mobile device to be rotated in the holder. The following patents are provided for reference only.

U.S. Pat. No. 7,424,110 issued to Whiten, III on Sep. 9, 2008 discloses a wrist clip consisting of left and right watch bands with a phone case located centrally and U.S. Pat. No. 7,757,913 issued to Fichera on Jul. 20, 2010 discloses a detachable belt clip interface mechanism for phone holsters and includes a wireless phone holster assembly for carrying a wireless phone.

A company called Scosche Industries offers an adjustable portable device holder for an iPod, iPhone, MP3, BlackBerry and cell phones that includes a 360 degree rotating head with a flexible shaft and ratcheting suction cup for a universal window mounting.

There are patents in the public domain that include visor clips for radar detectors, tissue dispensers, sunglasses, pens, picture frames, documents and the like, but there is no reference to a specific multi-purpose holder that can accept the majority of all types of mobile GPS navigation guidance devices that can be mounted onto a motor vehicle sun visor. The following patents are provided for reference only.

U.S. Design Pat. D296,771 issued to Dilgard on Jul. 19, 1988 and U.S. Design Pat. D310,167 issued to Reber, II on Aug. 28, 1990 both show visor clips for a radar detector and warning receiver respectively; U.S. Design Pat. D419,346 issued to Monigold on Jan. 25, 2000 shows a tissue dispenser sun visor clip; U.S. Design Pat. D482,268 issued to Kushner on Nov. 18, 2003 shows a football visor clip for sunglasses; and U.S. Design Pat. D489,764 issued to Richardson et al. shows a visor clip pen caddy.

U.S. Pat. No. 4,330,148 issued to LaMont on May 18, 1982 discloses an adjustable sun visor extender; U.S. Pat. No. 4,887,753 issued to Allen on Dec. 19, 1989 discloses a visor clip for mounting a police radar detector; U.S. Pat. No. 5,282,571 issued to Smith et al. on Feb. 1, 1994 discloses a plastic clip for automobile visors that is impregnated with an air-freshener; U.S. Pat. No. 5,489,078 issued to Risley on Feb. 6, 1996 discloses a one-piece clip for holding a round container; U.S. Pat. No. 6,477,744 issued to Miles on Nov. 12, 2002 discloses a visor clip for a vehicle visor as a one-piece member molded from a resilient material; U.S. Pat. No. 6,484,365 issued to Thompson on Nov. 26, 2002 discloses a visor clip of unitary construction including a payload portion for receiving a number of small objects such as toothpicks; and U.S. Pat. No. 6,491,194 issued to Marvin on Dec. 10, 2002 discloses a cell phone holder for motor vehicles.

A company called Speck Products makes a molded silicone skin cover for a few select mobile GPS navigation devices that includes a rigid plastic back plate and a rigid plastic clip with a tight opening for belt holsters, or for mounting on the standard swivel ball and suction cup hardware. The Speck Products molded silicone skin cover and holster clip cannot physically be used on a motor vehicle sun visor, because the clip opening is too small and is meant primarily to slip onto a belt and not a sun visor.

Technical Surveillance Equipment in Saluda, Calif. offers the Victoria GPS Vehicle Tracker that can clip onto a sun visor, but is used primarily for tracking a motor vehicle. The GPS transmitter and tracking device requires a monthly service for a fee and is not the same as the mobile GPS navigation device of the present invention. The two devices may use global positioning satellites to determine the location of the GPS devices, but the two devices function, look and operate differently and are used for different purposes.

Lastly, Akron Resources, Inc. markets and sells sun visor GPS mounts. They make different mounts for different GPS units. GPS mounts include a clip for mounting to a sun visor and a separate mating piece that stays with the GPS unit. The separate mating piece may connect to a swivel ball socket, dual T slots, or other clip configurations. The GPS unit is mounted to the sun visor without any cover or enclosed holder to help protect the GPS unit from scratches, abrasions, finger print marks, or other damages of the like.

### SUMMARY OF THE INVENTION

The holder of the present invention for a mobile device includes attaching portions for mounting to a motor vehicle sun visor, but adds the feature of a rotating portion, so that a mobile device like a cell phone or smartphone will allow the user to swivel the device from a portrait to a landscape position or vice-versa depending on preference. The accelerometer or tilt sensor located in most cell phone or smartphones will automatically rotate the touch screen display image depending on the orientation of the mobile device in the holder. Other mobile devices with built-in GPS modules that could be used with the present invention include iPods and iPads made by Apple Inc., PDAs and other compact tablets and computers.

The holder of the present invention for a mobile GPS navigation device includes attaching portions for mounting to a motor vehicle sun visor. The holder is primarily for use with a mobile GPS navigation system; however a cellular telephone, a radar detector, PDA or the like can also be inserted and hidden away if needed. The attaching portions include flexible clips, elastic straps, Velcro fasteners, double-sided sticking tape strips or hooks. The holder includes a large opening for receiving the mobile GPS navigation device with adjoining sides. The adjoining sides may include openings to provide access to the power switch, power charging jack, speaker, memory card and LCD touch screen. The holder further includes exterior projection fins for the clearance of sound from the speaker or for access to the charging jack of the mobile GPS navigation device. The projection fins also allow the mobile GPS navigation device to be lifted at an angle to allow better viewing of the LCD touch screen when the mobile GPS navigation device is mounted to a motor vehicle sun visor.

The preferred embodiment is a rigid holder with one receiving opening and adjoining sides. The holder is primarily made of plastic and is easily molded or vacuum formed. The holder can also be made from cloth fabric or leather. The holder can be molded with a plastic clip or the clip can be made from metal like spring steel and secured to the holder either by glue, friction, slides or locking tabs, welding and the like. The clip is designed to be flexible enough to slip over one edge of the sun visor while being strong enough to put tension on the sun visor for a secure and tight hold of the sun visor. One or more clips can be used for stability and a tighter hold on the sun visor. The clip is one type of attaching means for mounting the holder to a sun visor. Other attaching means can include elastic straps like rubber bands or the like. One or more elastic straps can be used for stability and a tighter hold on the sun visor. Velcro fasteners, double-sided sticking tape strips and hooks are additional attaching means that can be used as well to mount the holder to a sun visor. The holder includes various openings. The main opening is used for inserting and removing the mobile GPS navigation device from the holder. The other openings may be used for access to the power switch, power charging jack, speaker, memory card and LCD touch screen of the mobile GPS navigation device. The holder further includes exterior projections also made of rigid plastic for the clearance of sound from the speaker or for access to the charging jack of the mobile GPS navigation device. The projection fins can also be located on the clips instead of on the holder body. The projection fins also allow the mobile GPS navigation device to be lifted at an angle for better viewing of the LCD touch screen when the mobile GPS navigation device is mounted to a motor vehicle sun visor.

The alternate embodiment is a flexible protective holder made of silicone with a main opening and adjoining sides. The holder is made of silicone and is easily molded or formed. The holder can also be made from cloth fabric or leather. A plastic clip or a clip made of metal like spring steel can be secured to a rigid support plate that attaches directly to the holder or mobile GPS navigation device either by glue, friction clips, slides or locking tabs, welding and the like. The clip is designed to be flexible enough to slip over one edge of the sun visor while being strong enough to put tension on the sun visor for a secure and tight hold of the sun visor. One or more clips can be used for stability and a tighter hold on the sun visor. The clip is one type of attaching means for mounting the holder to a sun visor. Other attaching means can include elastic straps like rubber bands or the like. One or more elastic straps can be used for stability and a tighter hold on the sun visor. Velcro fasteners, double-sided sticking tape strips and hooks are additional attaching means that can be used as well to mount the holder to a sun visor. The holder includes various openings. The main opening is used for inserting and removing the mobile GPS navigation device from the holder. The other openings may be used for access to the power switch, power charging jack, speaker, memory card and LCD touch screen of the mobile GPS navigation device. The holder further includes exterior projection fins also made of rigid plastic for the clearance of sound from the speaker or for access to the charging jack of the mobile GPS navigation device. The projections fins may be part of the rigid support plate or located on the clips and also allow the mobile GPS navigation device to be lifted at an angle for better viewing of the LCD touch screen when the mobile GPS navigation device is mounted to a motor vehicle sun visor.

One or more rigid projection fins may be used. The projection fins can be located on opposite ends on one side of the holder, on the rigid support plate resting against the flat surface of the motor vehicle sun visor, or on one or more clips. The rigid projection fins may be molded directly into the rigid holder of the preferred embodiment, or it can be molded onto the rigid support plate for the alternate embodiment, or it can be formed directly onto one or more clips. The entire assembly is mounted and becomes an integral part of the sun visor. The exterior projection fins provide clearance for the sound from the speaker or for access to the charging jack of the mobile device. They also allow the mobile GPS navigation device to be lifted at a fixed angle for better viewing of the LCD touch screen when the mobile GPS navigation device is mounted to a motor vehicle sun visor.

For additional viewing of the LCD touch screen when the mobile GPS navigation device is mounted to a motor vehicle sun visor, the holder can be mounted on a pivot mechanism that will allow it to be tilted farther away from the flat surface of the motor vehicle sun visor. The pivot mechanism can include a separate hinge or at least one hole and mating dowel portion allowing the holder to be tilted away from the clip or rigid support plate that is attached to the sun visor for added viewing flexibility by the user.

The holder and clip assembly can be sold by direct marketing to consumers, on virtual on-line stores, to specialty stores, promotional marketers, advertisers and the like. The patent can be licensed to manufacturers or it can be made and sold directly to the manufacturers of the mobile GPS navigation devices. Some mobile GPS manufacturers include Tom Tom, Garmin, Mio, Navigon, and Magellan among many others. These mobile GPS navigation device manufacturers may even supply the present invention in all of their point of sale packages as an alternate mounting hardware for the consumer. The different company logos can be molded into the plastic mounting clips on the GPS holders, or they can be provided as a laser etched or durable marking label on metal mounting clips.

### OBJECT OF THE INVENTION

It is an object of the present invention to provide a holder for a mobile device that includes a cell phone, smartphone, or GPS navigation device.

It is an object of the present invention to provide a safer alternate mounting option for a mobile GPS navigation device for use in a motor vehicle.

It is also an object of the present invention to provide one holder that will accommodate the majority of different mobile GPS navigation devices.

It is another object of the present invention to provide better viewing of the mobile GPS navigation device LCD touch screen when mounted to a sun visor.

It is yet another object of the present invention to help reduce theft of the mobile GPS navigation device.

It is also another object of the present invention to provide a protective cover for the mobile GPS navigation devices from damage during normal use.

It is a final object of the invention to be made quickly using simple and inexpensive recyclable materials.

While the novel features of the invention are set forth particularly in the appended claims, the invention, both as to organization and content, will be better understood and appreciated along with other objects and features thereof, from the following detailed description taken in conjunction with the drawings.

### BRIEF DESCRIPTION OF THE DRAWINGS

FIG. 1 shows the preferred embodiment of the present invention in a front view and in a cross-sectional side view.

FIG. 2 shows an alternate embodiment of the present invention in a front view and in a cross-sectional side view.

FIG. 3 shows another alternate embodiment of the present invention in cross-sectional side views of a pivot mechanism for the present invention that includes a hinge showing the holder in both a closed and opened position.

FIG. 4 shows yet another alternate embodiment of the present invention in cross-sectional side views of a pivot mechanism for the present invention that includes at least one hole and mating dowel portion showing the holder in both a closed and opened position.

FIG. 5 shows an embodiment of the present invention in a front view and in a cross-sectional side view showing the rotating portion that includes a compression spring attaching the clip to the holder for positioning the mobile device.

FIG. 6 shows an alternate embodiment of the present invention in a front view and in a cross-sectional view showing the rotating portion that includes a compression spring attaching the clip to a rigid support plate that mounts to the holder for positioning the mobile device.

The foregoing has outlined rather broadly the features and technical advantages of the present invention, so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

### DETAILED DESCRIPTION

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

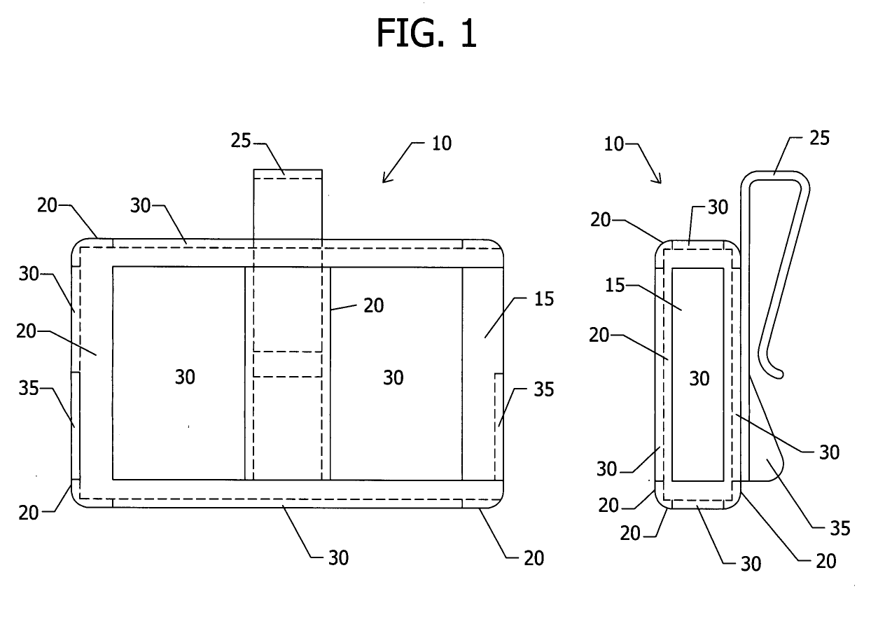

FIG. 1 shows a preferred embodiment of the holder 10 of the present invention in both a front view and a cross-sectional side view. The preferred embodiment is a rigid protective holder 10 having a main opening 15 and adjoining sides 20. The holder 10 is primarily made of plastic and is easily molded or vacuum formed. The holder 10 can also be made from cloth fabric or leather. The holder 10 can also be molded with a plastic clip 25 or the clip 25 can be made from metal like spring steel and secured to the holder 10 either by glue, friction, slides or locking tabs, welding and the like (not shown). The clip 25 is designed to be flexible enough to slip over one edge of the sun visor (not shown) while being strong enough to put tension on the sun visor for a secure and tight hold of the sun visor. One or more clips 25 can be used for stability and a tighter hold on the sun visor. The clip 25 is one type of attaching means for mounting the holder 10 to a sun visor. Other attaching means can include elastic straps like rubber bands or the like (not shown). One or more elastic straps can be used for stability and a tighter hold on the sun visor. Velcro fasteners, double-sided sticking tape strips and hooks are additional attaching means that can be used as well to mount the holder 10 to a sun visor. The holder 10 includes various additional openings 30. The main opening 15 is used for inserting and removing the mobile GPS navigation device (not shown) from the holder 10. The additional openings 30 may be used for access to the power switch, power charging jack, speaker, memory card and LCD touch screen (not shown) of the mobile GPS navigation device. The holder 10 further includes exterior projection fins 35 also made of rigid plastic for the clearance of sound from the speaker or for access to the charging jack of the mobile GPS navigation device. The projection fins 35 can also be located on the clips 25 instead of on the body of holder 10. The projection fins 35 also allow the mobile GPS navigation device to be lifted at an angle for better viewing of the LCD touch screen when the mobile GPS navigation device is mounted to a motor vehicle sun visor.

One or more rigid projection fins 35 may be used. The projection fins 35 can be located on opposite ends on one side of adjoining sides 20 of the holder 10 or on one or more clips 25. The rigid projection fins 35 may be molded directly into the rigid holder 10 of the preferred embodiment, or it can be formed directly onto one or more clips 25. The holder 10 and clip 25 assembly is mounted and becomes an integral part of the sun visor. The exterior projection fins 35 provide clearance for the sound from the speaker or for access to the charging jack of the mobile GPS navigation device. They also allow the mobile GPS navigation device to be lifted at an angle for better viewing of the LCD touch screen when the mobile GPS navigation device is mounted to a motor vehicle sun visor.

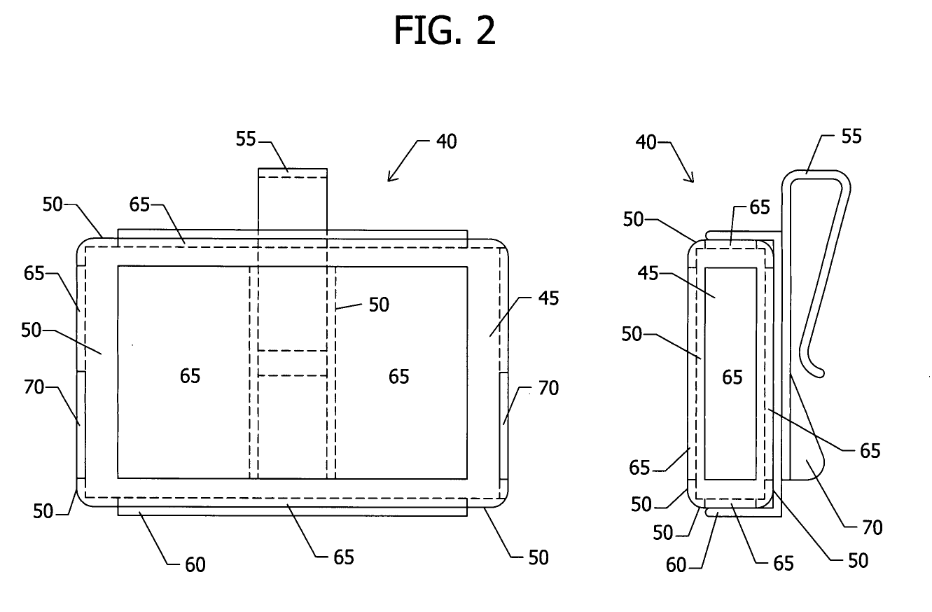

FIG. 2 shows an alternate embodiment of the holder 40 of the present invention in both a front view and a cross-sectional side view. The alternate embodiment is a flexible protective holder 40 having a main opening 45 and adjoining sides 50. The holder 40 is made of silicone rubber and is easily molded or formed. The holder 40 can also be made from cloth fabric or leather. A plastic clip 55 or a clip 55 made of metal like spring steel can be secured to a rigid support plate 60 that attaches directly to the holder 40 or mobile GPS navigation device (not shown) either by glue, friction clips, slides or locking tabs, welding and the like (not shown). The clip 55 is designed to be flexible enough to slip over one edge of the sun visor (not shown) while being strong enough to put tension on the sun visor for a secure and tight hold of the sun visor. One or more clips 55 can be used for stability and a tighter hold on the sun visor. The clip 55 is one type of attaching means for mounting the holder 40 to a sun visor. Other attaching means can include elastic straps like rubber bands or the like (not shown). One or more elastic straps can be used for stability and a tighter hold on the sun visor. Velcro fasteners, double-sided sticking tape and hooks are additional attaching means that can be used as well to mount the holder 40 to a sun visor. The holder 40 includes additional openings 65. The main opening 45 is used for inserting and removing the mobile GPS navigation device from the holder 40. The additional openings 65 may be used for access to the power switch, power charging jack, speaker, memory card and LCD touch screen (not shown) of the mobile GPS navigation device. The holder 40 further includes exterior projection fins 70 also made of rigid plastic for the clearance of sound from the speaker or for access to the charging jack of the mobile GPS navigation device. The projections fins 70 may be part of the rigid support plate 60 or located on the clips 55, and also allow the mobile GPS navigation device to be lifted at an angle for better viewing of the LCD touch screen when the mobile GPS navigation device is mounted to a motor vehicle sun visor.

One or more rigid projection fins 70 may be used. The projection fins 70 can be located on opposite ends on the rigid support plate 60 resting against the flat surface of the motor vehicle sun visor or on one or more clips 55. The rigid projection fins 70 may be molded directly into the rigid support plate 60 that also contains the attaching means to the holder 40 or to the mobile GPS navigation device itself for the alternate embodiment or it can be formed directly onto one or more clips 55. The assembly consisting of holder 40, rigid support plate 60 and one or more clips 55 is mounted and becomes an integral part of the sun visor. The exterior projection fins 70 provide clearance for the sound from the speaker or for access to the charging jack of the mobile GPS navigation device. They also allow the mobile GPS navigation device to be lifted at an angle for better viewing of the LCD touch screen when the mobile GPS navigation device is mounted to a motor vehicle sun visor.

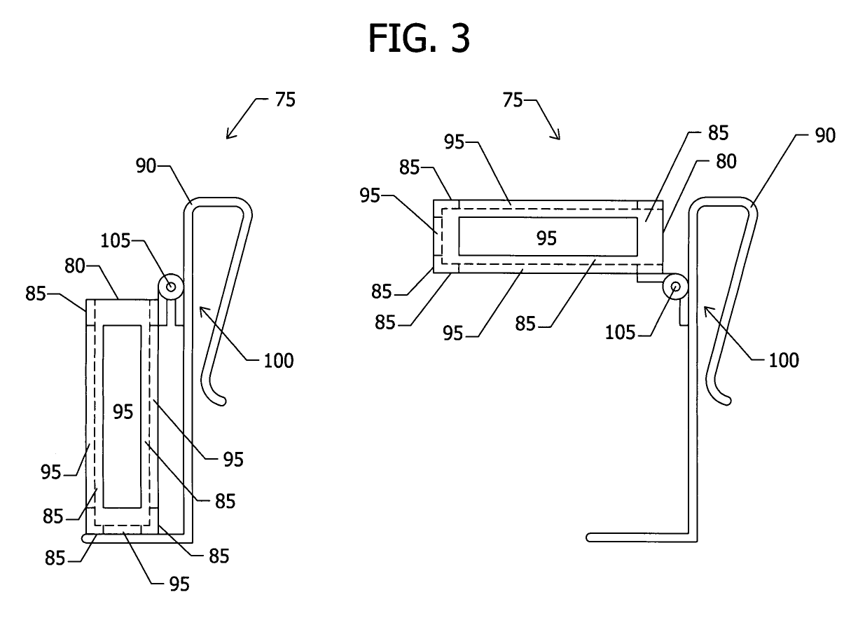

FIG. 3 shows another alternate embodiment of a holder 75 of the present invention in cross-sectional side views with a pivot mechanism 100 for the present invention that includes a hinge 105 showing the holder 75 in both a closed and opened tilted position. For additional viewing of the LCD touch screen when the mobile GPS navigation device (not shown) is mounted to a motor vehicle sun visor (not shown), the holder 75 can be mounted on a pivot mechanism 100 that will allow it to be tilted farther away from the flat surface of the sun visor of a motor vehicle. The pivot mechanism 100 can include a separate hinge 105 allowing the holder 75 to be tilted away from a clip 90 that is attached to the sun visor for added viewing flexibility by the user.

The alternate embodiment is a protective holder 75 having a main opening 80 and adjoining sides 85. The holder 75 is made of plastic or silicone rubber and is easily molded or formed. The holder 75 can also be made from cloth fabric or leather. A plastic clip 90 or a clip 90 made of metal like spring steel can be secured directly to the holder 75 and hinge 105 either by glue, friction clips, slides, welding, molding or locking tabs, and the like (not shown). The clip 90 is designed to be flexible enough to slip over one edge of the sun visor (not shown) while being strong enough to put tension on the sun visor for a secure and tight hold of the sun visor. One or more clips 90 can be used for stability and a tighter hold on the sun visor. The clip 90 is one type of attaching means for mounting the holder 75 to a sun visor. Other attaching means can include elastic straps like rubber bands or the like (not shown). One or more elastic straps can be used for stability and a tighter hold on the sun visor. Velcro fasteners, double-sided sticking tape strips and hooks (not shown) are additional attaching means that can be used as well to mount the holder 75 to a sun visor. The holder 75 includes additional openings 95. The main opening 80 is used for inserting and removing the mobile GPS navigation device from the holder 75. The additional openings 95 may be used for access to the power switch, power charging jack, speaker, memory card and LCD touch screen (not shown) of the mobile GPS navigation device.

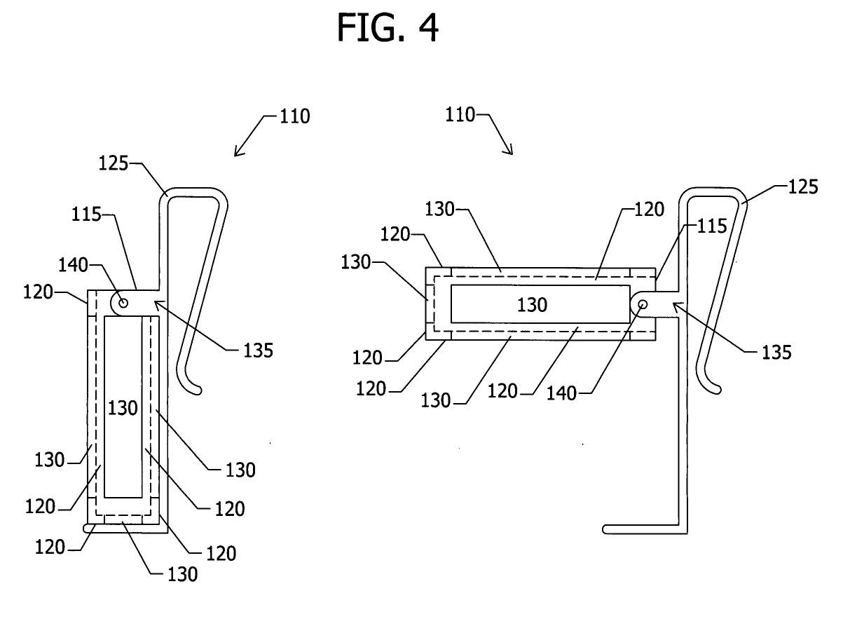

FIG. 4 shows yet another alternate embodiment of a holder 110 of the present invention shown in cross-sectional side views of a pivot mechanism 135 for the present invention that includes a hole and mating dowel portion 140 showing the holder 110 in both a closed and opened tilted position. Another hole and mating dowel portion (not shown) is located on the other side. For additional viewing of the LCD touch screen when the mobile GPS navigation device (not shown) is mounted to a motor vehicle sun visor (not shown), the holder 110 can be mounted on a pivot mechanism 135 that will allow it to be tilted farther away from the flat surface of the motor vehicle sun visor. The pivot mechanism 135 can include at least one hole and mating dowel portion 140 allowing the holder 110 to be tilted away from the clip 125 that is attached to the sun visor for added viewing flexibility by the user.

The alternate embodiment is a protective holder 110 having a main opening 115 and adjoining sides 120. The holder 110 is made of plastic or silicone rubber and is easily molded or formed. The holder 110 can also be made from cloth fabric or leather. A plastic clip 125 or a clip 125 made of metal like spring steel can be secured directly to the holder 110 and at least one hole and mating dowel portion 140 either by glue, friction clips, slides, welding, molding or locking tabs and the like (not shown). The clip 125 is designed to be flexible enough to slip over one edge of the sun visor (not shown) while being strong enough to put tension on the sun visor for a secure and tight hold of the sun visor. One or more clips 125 can be used for stability and a tighter hold on the sun visor. The clip 125 is one type of attaching means for mounting the holder 110 to a sun visor. Other attaching means can include elastic straps like rubber bands or the like (not shown). One or more elastic straps can be used for stability and a tighter hold on the sun visor. Velcro fasteners, double-sided sticking tape strips and hooks are additional attaching means that can be used as well to mount the holder 110 to a sun visor. The holder 110 includes additional openings 130. The main opening 115 is used for inserting and removing the mobile GPS navigation device from the holder 110. The additional openings 130 may be used for access to the power switch, power charging jack, speaker, memory card and LCD touch screen (not shown) of the mobile GPS navigation device.

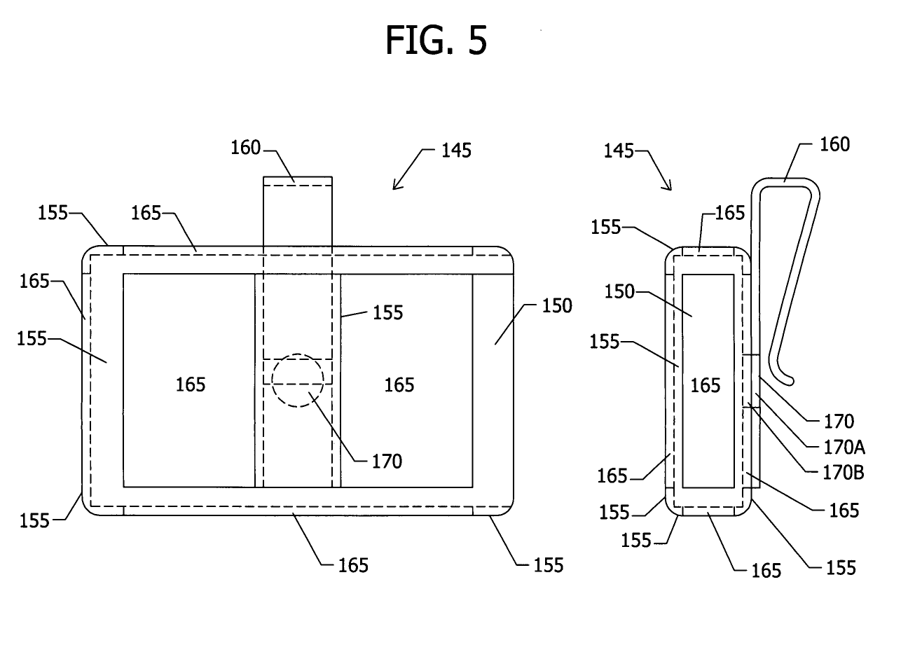

FIG. 5 shows an embodiment of a holder 145 of the present invention shown in a front view and in a cross-sectional side view showing the rotating portion 170 for the present invention that includes a compression spring (not shown) attaching the clip 160 to the holder 145 adjustable for both a portrait and landscape positioning of the mobile device (not shown) placed in the holder 145. The two mating surfaces 170A and 170B can also be made with interlocking ribs (not shown) for precise positive positioning of the holder 145 to the clip 160.

This embodiment includes a protective holder 145 having a main opening 150 and adjoining sides 155. The holder 145 is made of plastic or silicone rubber and is easily molded or formed. The holder 145 can also be made from cloth fabric or leather. A plastic clip 160 or a clip 160 made of metal like spring steel can be secured directly to the holder 145 and to rotating portion 170 either by springs, threaded screw and nut, pin and receptacle connectors, rivets, grommets, snap in surfaces, push button interlocking surfaces, ball and cup, bearings and the like (not shown). The clip 160 is designed to be flexible enough to slip over one edge of the sun visor (not shown) while being strong enough to put tension on the sun visor for a secure and tight hold of the sun visor. One or more clips 160 can be used for stability and a tighter hold on the sun visor. The clip 160 is one type of attaching means for mounting the holder 145 to a sun visor. Other attaching means can include elastic straps like rubber bands or the like (not shown). One or more elastic straps can be used for stability and a tighter hold on the sun visor. Velcro fasteners, double-sided sticking tape strips and hooks are additional attaching means that can be used as well to mount the holder 145 to a sun visor. The holder 145 includes additional openings 165. The main opening 150 is used for inserting and removing the mobile device from the holder 145. The additional openings 165 may be used for access to one or more of the following components that may be available on the mobile device including the power switch, power charging jack, speaker, memory card, camera, flash, microphone, keypad, volume adjust, headphone jack, HDMI video jack, LCD or image touch screen.

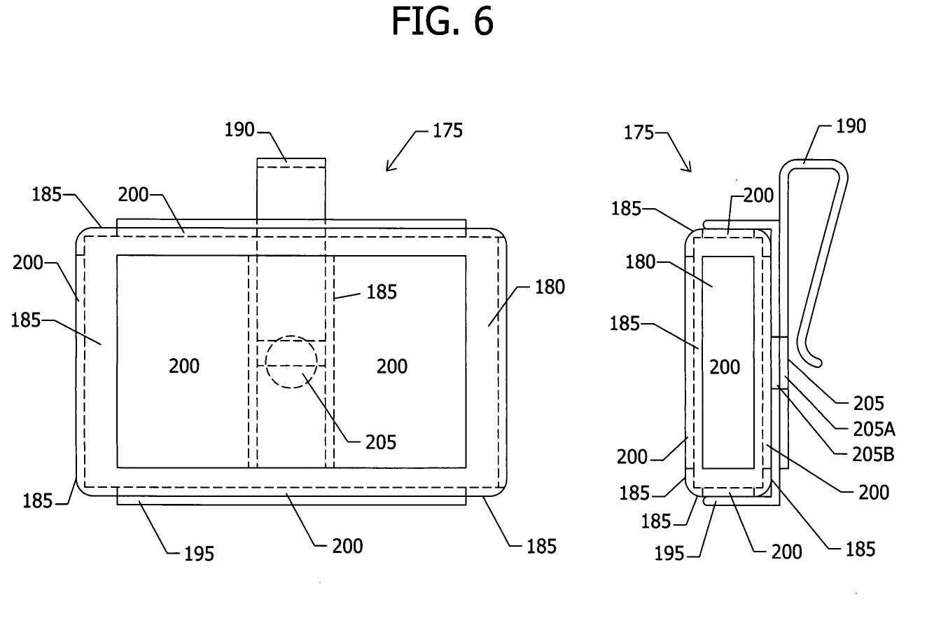

FIG. 6 shows an alternate embodiment of a holder 175 of the present invention shown in a front view and in a cross-sectional side view showing the rotating portion 205 for the present invention that includes a compression spring (not shown) attaching the clip 190 onto a rigid mounting plate 195 connected to the holder 175 adjustable for both a portrait and landscape positioning of the mobile device (not shown) placed in the holder 175. The two mating surfaces 205A and 205B can also be made with interlocking ribs (not shown) for precise positive positioning of the holder 175 and rigid mounting plate 195 to the clip 190.

This embodiment includes a protective holder 175 having a main opening 180 and adjoining sides 185. The holder 175 is made of plastic or silicone rubber and is easily molded or formed. The holder 175 can also be made from cloth fabric or leather. A plastic clip 190 or a clip 190 made of metal like spring steel can be secured to a rigid support plate 195 that attaches directly to the holder 175 and to rotating portion 205 either by springs, threaded screw and nut, pin and receptacle connectors, rivets, grommets, snap in surfaces, push button interlocking surfaces, ball and cup, bearings and the like (not shown). The clip 190 is designed to be flexible enough to slip over one edge of the sun visor (not shown) while being strong enough to put tension on the sun visor for a secure and tight hold of the sun visor. One or more clips 190 can be used for stability and a tighter hold on the sun visor. The clip 190 is one type of attaching means for mounting the holder 175 to a sun visor. Other attaching means can include elastic straps like rubber bands or the like (not shown). One or more elastic straps can be used for stability and a tighter hold on the sun visor. Velcro fasteners, double-sided sticking tape strips and hooks are additional attaching means that can be used as well to mount the holder 175 to a sun visor. The holder 175 includes additional openings 200. The main opening 180 is used for inserting and removing the mobile device from the holder 175. The additional openings 200 may be used for access to one or more of the following components that may be available on the mobile device including the power switch, power charging jack, speaker, memory card, camera, flash, microphone, keypad, volume adjust, headphone jack, HDMI video jack, LCD or image touch screen.

It will be understood that various changes in the details, materials, types, values, and arrangements of the components that have been described and illustrated in order to explain the nature of this invention may be made by those skilled in the art without departing from the principle and scope of the invention as expressed in the following claims.

What is claimed is:

1. A holder for a mobile device for mounting to a sun visor including:
a main opening for inserting and removing said mobile device;
sides adjoining said main opening;
additional openings on said sides;
at least one attaching portion for mounting said holder to said sun visor;
and a portion for rotating said holder.

2. A holder for a mobile device for mounting to a sun visor as set forth in claim 1, wherein said at least one attaching portion includes at least one clip.

3. A holder for a mobile device for mounting to a sun visor as set forth in claim 2, wherein said at least one clip is made of plastic.

4. A holder for a mobile device for mounting to a sun visor as set forth in claim 2, wherein said at least one clip is made of metal.

5. A holder for a mobile device for mounting to a sun visor as set forth in claim 1, wherein said at least one attaching portion includes at least one elastic strap.

6. A holder for a mobile device for mounting to a sun visor as set forth in claim 1, wherein said at least one attaching portion includes at least one Velcro fastener.

7. A holder for a mobile device for mounting to a sun visor as set forth in claim 1, wherein said at least one attaching portion includes at least one strip of double-sided sticking tape.

8. A holder for a mobile device for mounting to a sun visor as set forth in claim 1, wherein said at least one attaching portion includes at least one hook.

9. A holder for a mobile device for mounting to a sun visor as set forth in claim 1, wherein said additional openings on said sides provide access to the power switch, power charging jack, speaker, memory card, camera, flash, microphone, keypad, volume adjust, headphone jack, HDMI video jack, LCD or image touch screen.

10. A holder for a mobile device for mounting to a sun visor as set forth in claim 1, wherein said portion for rotating includes at least one compression spring on two surfaces.

11. A holder for a mobile device for mounting to a sun visor as set forth in claim 1, wherein said mobile device is a cell phone.

12. A holder for a mobile device for mounting to a sun visor as set forth in claim 1, wherein said mobile device is a smartphone.

13. A holder for a mobile device for mounting to a sun visor as set forth in claim 1, wherein said mobile device is a portable GPS navigation device.

14. A holder for a mobile device for mounting to a sun visor as set forth in claim 1, wherein said holder is made of plastic.

15. A holder for a mobile device for mounting to a sun visor as set forth in claim 1, wherein said holder is made of rubber.

16. A holder for a mobile device for mounting to a sun visor as set forth in claim 1, wherein said holder is made of cloth fabric.

17. A holder for a mobile device for mounting to a sun visor as set forth in claim 1, wherein said holder is made of leather.

18. A holder for a mobile device for mounting to a sun visor including:
a main opening for inserting and removing said mobile device;
sides adjoining said main opening;
additional openings on said sides;
a rigid support plate;
at least one attaching portion located on said rigid support plate for mounting said holder to said sun visor;
and a portion for rotating said rigid support plate and said holder.

19. A holder for a mobile device for mounting to a sun visor as set forth in claim 18, wherein said at least one attaching portion located on said rigid support plate includes at least one clip.

20. A holder for a mobile device for mounting to a sun visor as set forth in claim 19, wherein said at least one clip is made of plastic.

21. A holder for a mobile device for mounting to a sun visor as set forth in claim 19, wherein said at least one clip is made of metal.

22. A holder for a mobile device for mounting to a sun visor as set forth in claim 18, wherein said at least one attaching portion located on said rigid support plate includes at least one elastic strap.

23. A holder for a mobile device for mounting to a sun visor as set forth in claim 18, wherein said at least one attaching portion located on said rigid support plate includes at least one Velcro fastener.

24. A holder for a mobile device for mounting to a sun visor as set forth in claim 18, wherein said at least one attaching portion located on said rigid support plate includes at least one strip of double-sided sticking tape.

25. A holder for a mobile device for mounting to a sun visor as set forth in claim 18, wherein said at least one attaching portion located on said rigid support plate includes at least one hook.

26. A holder for a mobile device for mounting to a sun visor as set forth in claim 18, wherein said additional openings on said sides provide access to the power switch, power charging jack, speaker, memory card, camera, flash, microphone, keypad, volume adjust, headphone jack, HDMI video jack, LCD or image touch screen.

27. A holder for a mobile device for mounting to a sun visor as set forth in claim 18, wherein said portion for rotating includes at least one compression spring on two surfaces.

28. A holder for a mobile device for mounting to a sun visor as set forth in claim 18, wherein said mobile device is a cell phone.

29. A holder for a mobile device for mounting to a sun visor as set forth in claim 18, wherein said mobile device is a smartphone.

30. A holder for a mobile device for mounting to a sun visor as set forth in claim 18, wherein said mobile device is a portable GPS navigation device.

31. A holder for a mobile device for mounting to a sun visor as set forth in claim 18, wherein said holder is made of plastic.

32. A holder for a mobile device for mounting to a sun visor as set forth in claim 18, wherein said holder is made of rubber.

33. A holder for a mobile device for mounting to a sun visor as set forth in claim 18, wherein said holder is made of cloth fabric.

34. A holder for a mobile device for mounting to a sun visor as set forth in claim 18, wherein said holder is made of leather.
